(19) United States
(12) Patent Application Publication
(10) Pub. No.: US 2010/0258248 A1
(43) Pub. Date: Oct. 14, 2010

(54) APPLICATOR PORTION OF A LINERED TAPE APPLICATOR

(76) Inventor: Jack L. Perecman, Golden Valley, MN (US)

Correspondence Address: 3M INNOVATIVE PROPERTIES COMPANY, PO BOX 33427, ST. PAUL, MN, 55133-3427, US

(21) Appl. No.: 12/678,500

(22) PCT Filed: Sep. 3, 2008
(86) PCT No.: PCT/US08/75095

§ 371 Date: Jun. 24, 2010

Related U.S. Application Data
(60) Provisional application No. 60/972,927, filed on Sep. 17, 2007.

(51) Int. Cl. B32B 37/00

(52) U.S. Cl. 156/349

(57) ABSTRACT

The applicator portion of a linered tape applicator is described. The applicator portion includes an applicator roll, a first idler roll positioned in a tape path prior to the applicator roll and a second idler roll positioned in a liner path subsequent to the applicator roll. The applicator roll, the first idler roll, and the second idler roll are coupled to a raising mechanism. The raising mechanism is selected such that when the applicator roll is raised by a distance X, the first idler roll and the second idler roll are raised by one-half X.

### CROSS-REFERENCE TO RELATED APPLICATION

This application claims the benefit of U.S. Provisional Patent Application No. 60/972,927, filed Sep. 17, 2007, the disclosure of which is incorporated by reference herein in its entirety.

### FIELD

The present disclosure relates to the applicator portion of a tape applicator.

### SUMMARY

Briefly, in one aspect, the present disclosure provides an applicator portion of a tape applicator comprising an applicator roll, a first idler roll positioned in a tape path prior to the applicator roll and a second idler roll positioned in a liner path subsequent to the applicator roll. The applicator roll, the first idler roll, and the second idler roll are coupled to a raising mechanism. The raising mechanism is selected such that when the applicator roll is raised by a distance X, the first idler roll and the second idler roll are raised by one-half X.

In some embodiments, the raising mechanism comprises a gripper cylinder comprising a first segment and a second segment movably coupled to a body positioned there between. The first idler roll and the second idler roll are coupled to the body, and the applicator roll is coupled to the second segment.

In some embodiments, the applicator portion further comprises a frame, wherein the first segment of the gripper cylinder is affixed to the frame. In some embodiments, a first slider arm couples the applicator roll to the second segment of the gripper cylinder. In some embodiments, a second slider arm couples the first idler roll and the second idler roll to the body of the gripper cylinder.

In some embodiments, the raising mechanism comprises a fixed gear rack, a movable gear rack, and a spur gear positioned there between. The first idler roll and the second idler roll are coupled to the spur gear and the applicator roll is coupled to the movable gear rack.

In some embodiments, the applicator portion further comprises a frame, wherein the fixed gear rack is affixed to the frame. In some embodiments, a first slider arm couples the applicator roll to the movable gear rack. In some embodiments, a second slider arm couples the first idler roll and the second idler roll to the spur gear.

In some embodiments, the applicator portion further comprises a third idler roll positioned in the tape path prior to the first idler roll and a fourth idler roll positioned in the liner path subsequent to the second applicator roll. In some embodiments, the applicator portion further comprises wherein the third idler roll and the fourth idler are affixed to the frame.

In another aspect, the present disclosure provides a linered tape applicator comprising an applicator portion. The applicator portion comprises an applicator roll, a first idler roll positioned in a tape path prior to the applicator roll and a second idler roll positioned in a liner path subsequent to the applicator roll, wherein the applicator roll, the first idler roll, and the second idler roll are coupled to a raising mechanism, and wherein the raising mechanism is selected such that when the applicator roll is raised by a distance X, the first idler roll and the second idler roll are raised by one-half X.

In some embodiments, the linered tape applicator further comprises a tensioning wheel having a peripheral surface, a tape path, and liner path. The tape path comprises a tape feed portion extending to the peripheral surface, a tape wrap portion forming a first wrap angle relative to the peripheral surface, and a tape applying portion extending from the peripheral surface to the tape applicator roll. The liner path comprises a linered-tape portion corresponding to the tape path, a liner wrap portion forming a second wrap angle relative to the peripheral surface, a liner tensioning portion extending from the tape applicator roll to the liner wrap portion, and liner rewind portion extending from the liner wrap portion to a liner rewind.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE FIGURES

FIG. 1 illustrates an exemplary linered tape applicator according to some embodiments of the present disclosure.

FIG. 2 illustrates the cross-section of an exemplary linered tape that may be used in some embodiments of the present disclosure.

FIG. 3 illustrates some elements of an exemplary linered tape applicator according to some embodiments of the present disclosure.

FIGS. 4a-4c illustrate an exemplary applicator portion of a linered tape applicator according to some embodiments of the present disclosure.

FIG. 5 illustrates an exemplary linered tape applicator incorporating an applicator portion according to some embodiments of the present disclosure.

FIGS. 6a and 6b illustrate an applicator portion according to some embodiments of the present disclosure.

FIGS. 7a and 7b illustrate of one exemplary means for moving the applicator and idler rolls of the applicator portion of FIGS. 6a and 6b.

FIGS. 8a and 8b illustrate a second exemplary means for moving the applicator and idler rolls of the applicator portion of FIGS. 6a and 6b.

### DETAILED DESCRIPTION

It is often desirable to apply tape to a surface, either by moving a substrate relative to a fixed taping head, or by moving a taping head relative to a fixed substrate. In some cases both the taping head and the substrate may be moved relative to each other. In some situations, e.g., when applying a transfer adhesive or a double-coated tape, a liner will be provided on one side of the tape. In some situations, the liner may be applied to a substrate along with the tape. However, in some situations it may be desirable to remove the liner as the tape is applied.

The present inventor has discovered that it may be important to maintain some level of tension in both the tape and the removed liner throughout the tape application process. The present inventor has also discovered that it may be desirable to maintain a constant tension in the liner throughout the application process, regardless of the size of the tape supply roll or the speed of tape application.

In some applications, it may be necessary to apply tape to precise locations on successive parts. The present inventor has also discovered that it may be desirable to maintain the location of the tape fixed relative to the applicator roll as the applicator roll is raised and lowered between successive parts.

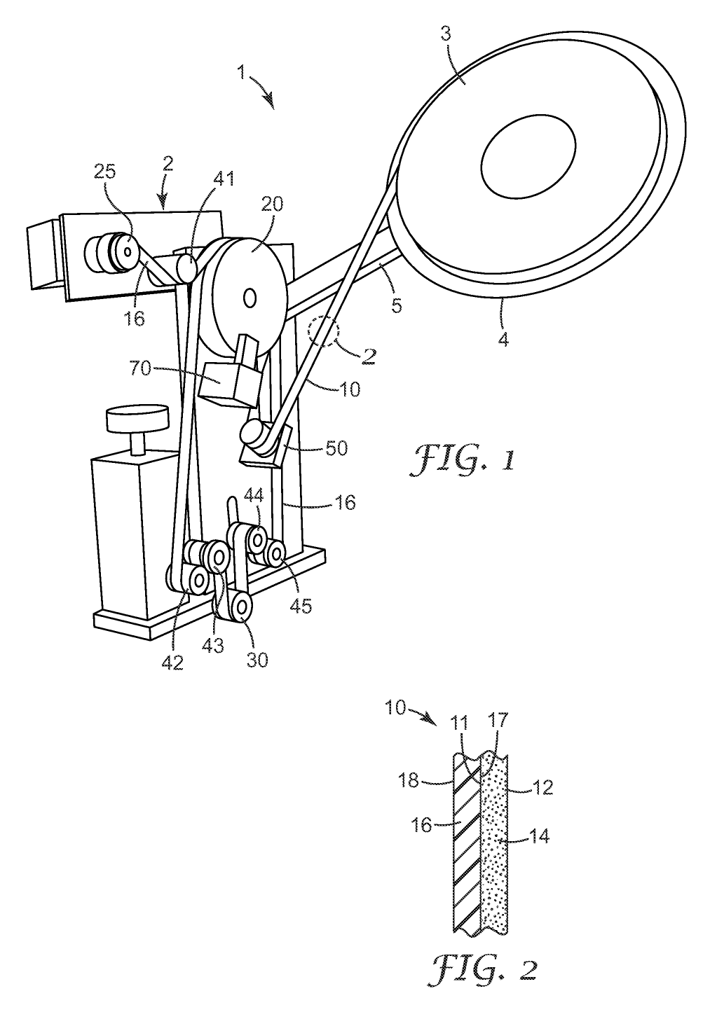

Exemplary linered tape applicator 1 according to some embodiments of the present disclosure is shown in FIG. 1. Generally, tape applicator 1 includes frame 2 to which selected elements may be attached including, e.g., tape support 4, which is mounted to frame 2 via support arm 5. Linered tape applicator 1 may also include one or more idler rolls, e.g., idler rolls 41, 42, and 43. These idler rolls, as well as other elements, may be attached to achieve a desired tape path leading tape 10 from tape supply 3, around tensioning wheel 20, to applicator roll 30. Similarly, additional idler rolls, e.g., idler rolls 44 and 45, and other elements may be added to achieve a desired liner path for liner 16, which follows the tape path to applicator roll 30 and continues on to wrap tensioning wheel 20 and on to liner rewind 25. Additional optional elements may also be included, e.g., tape plane roller 50 and brake 70.

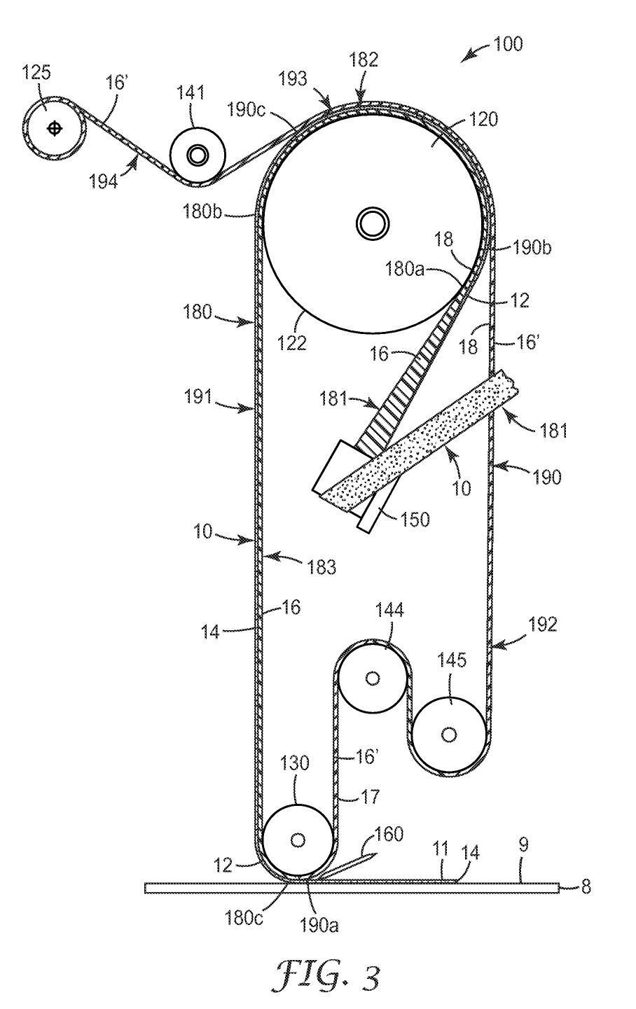

Referring to FIG. 2, exemplary tape 10 comprises first adhesive surface 11 and second adhesive surface 12 located on opposite sides of core 14. Tape 10 also includes liner 16. In some embodiments, the first and or second adhesive surfaces may be integral to the core. For example, some unsupported adhesive films and adhesive foams are tacky and their surfaces are adhesive surfaces. In some embodiments, one or both adhesives surfaces may be provided by a separate adhesive layer bonded directly to the core layer. In some embodiments, one or both adhesive surfaces may be provided by a separate adhesive layer indirectly bonded to the core layer, i.e., one or more additional layer(s) (e.g., primer layers and/or support layer(s)) may be located between the adhesive layer and the core layer.

Generally, any known adhesive may be used, including pressure sensitive adhesives (e.g., acrylates, rubbers, block copolymers, and the like), activated adhesives (e.g., heat-activated or moisture-activated adhesives), and curable adhesives (e.g., thermoset adhesives). Generally, any known core materials may be used. For example, the core may comprise one or more of, e.g., paper, polymeric film, foam (e.g., adhesive foams), fibrous webs (e.g., woven and nonwoven webs, scrims, and the like), metals (e.g., foils) and the like.

Liner 16 includes first liner surface 17, which is in contact with first adhesive surface 11, and second liner surface 18. Any known liner may be used including those comprising paper or polymeric film substrates. One or both liner surfaces may include a release material, e.g., silicones, fluoropolymers, fluorosilicones, polyolefins, and the like.

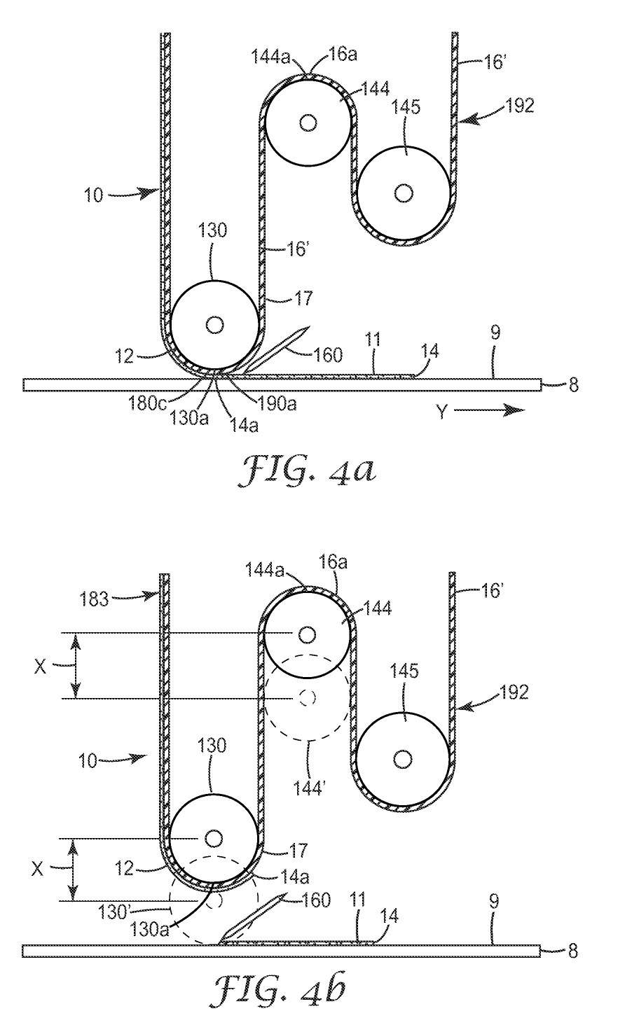

Additional details of the elements of one exemplary linered tape applicator according to some embodiments of the present disclosure are shown in FIG. 3. Generally, tape applicator 100 includes a frame (not shown) to which selected elements may be attached to achieve tape path 180 and liner path 190.

Tape path 180 includes tape feed portion 181 extending from a supply of tape (not shown) to point 180a where second liner surface 18 of liner 16 comes into contact with peripheral surface 122 of tensioning wheel 120. Generally, any tape path may be used to feed tape from a supply roll to the tensioning wheel provided that the linered side of tape 10 contacts peripheral surface 122. In some embodiments, tape may be supplied at some angle relative to peripheral surface 122. In some embodiments, tape feed portion 181 of tape path 180 includes tape plane roller 150 to assist in rotating the tape to bring second liner surface 18 into contact with peripheral surface 122.

Liner 16, attached to tape 10, is in contact with and wraps at least a portion of peripheral surface 122 of tensioning wheel 120 defining tape wrap portion 182 of tape path 180. Tape wrap portion 182 extends from point 180a where second liner surface 18 first comes into contact with peripheral surface 122 of tensioning wheel 120, to point 180b where the second liner surface ends its contact with peripheral surface 122. In some embodiments, the tape wrap angle, i.e., the included angle between points 180a and 180b, is at least 45 degrees, and, in some embodiments, at least 90 degrees, at least 180 degrees, at least 270 degrees, or even at least 300 degrees. Properly positioned guides, e.g., idler rolls may be required to obtain the desired tape wrap angle.

Tape path 180 also includes tape applying portion 183 extending from point 180b where the second liner surface ends its contact with peripheral surface 122 to point 180c at applicator roll 130 where second adhesive surface 12 contacts substrate 8, bonding core 14 to substrate surface 9. In some embodiments, point 180c is located directly below the center of the tape applicator roll.

Still referring to FIG. 3, liner path 190 includes a first portion where liner 16 is associated with first adhesive surface 11 of tape 10, and a second portion where liner 16 has been removed to expose first adhesive surface 11. For the sake of clarity, the liner will be identified as 16 prior to being removed from tape 10 near applicator roll 30. After the liner is removed from the tape, it will be identified as 16′.

The first portion of liner path 190 corresponds identically to that part of tape path 180 wherein liner 16 is attached to the first adhesive surface of tape 10, i.e., from the tape supply roll, around tensioning roll 120, to point 190a. Point 190a indicates the location where liner 16 is removed, i.e., the location where first release surface 17 is separated from first adhesive surface 11. This portion of liner path 190 is referred to as linered-tape portion 191. In some embodiments, point 190a corresponds to point 180c.

The second portion of liner path 190 includes liner tensioning portion 192, liner wrap portion 193, and liner rewind portion 194. Liner tensioning portion 192 begins at point 190a where liner 16′ is removed from first adhesive surface 11. Liner tensioning portion 192 extends to point 190b where second liner surface 18 contacts second adhesive surface 12 of tape 10 near the peripheral surface of tensioning wheel 120. In some embodiments, as liner 16′ traverses liner tensioning portion 192 of liner path 190, it passes around one or more optional idler rolls, e.g., idler rolls 144 and 145.

Liner wrap portion 193 consists of that portion of liner path 190 where liner 16′ is in temporary contact with second adhesive surface 12 beginning at point 190b and extending to point 190c. In some embodiments, the liner wrap angle (i.e., the included angle between points 190b and 190c) is less than or equal to the tape wrap angle. In some embodiments, the liner wrap angle is at least 45 degrees, and, in some embodiments, at least 90 degrees, at least 120 degrees, at least 180 degrees, or even at least 270 degrees. Properly positioned guides, e.g., idler rolls may be required to obtain the desired liner wrap angle.

Liner path 190 also includes liner rewind portion 194, which extends from the point where liner 16′ is removed from second adhesive surface 12 of tape 10 (i.e., point 190c), around one or more optional idler rolls, e.g., idler roll 141, to liner rewind 125. In some embodiments, a stripping roll or plate may be used to assist in removing the liner from the second adhesive surface.

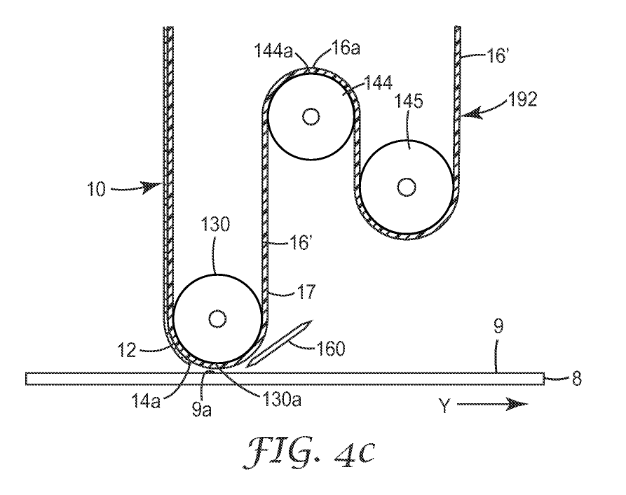

The applicator portion of exemplary linered tape applicator 100 of FIG. 3 is shown in greater detail in FIGS. 4a, 4b, and 4c. The linered tape applicator may be operated as follows. Referring to FIG. 4a, idler roll 144 and applicator roll 130 are in their lowered position (i.e., moved away from the tensioning wheel) bringing second adhesive surface 12 of tape 10 into contact with substrate surface 9 at the desired pressure. The lowering of the rolls and application of pressure may be achieved using, e.g., a pneumatic cylinder or other means known in the art.

Generally, the linered tape applicator may be positioned at any orientation relative to the ground; thus, as used herein, the term “raised” means positioned or moved near the tensioning wheel, while “lowered” means positioned or moved away from the tensioning wheel. Thus, when the linered tape applicator is upright, i.e., the tensioning wheel is above the applicator roll, the height of the applicator roll relative the ground increases when the applicator roll is “raised” toward the tensioning wheel. In contrast, if the linered tape applicator is inverted such that the tensioning wheel is below the applicator roll, the height of the applicator roll relative to the ground decreases as the applicator roll is “raised” toward the tensioning wheel.

Referring to FIG. 3, liner rewind 125 is operated on a clutch. The clutch is set such that liner rewind 125 slips when substrate 8 is stationary; thus, no liner is being rewound. A relative motion is then created between the substrate and the tape applicator, causing applicator roll 130 to rotate. For example, in some embodiments, substrate 8 is moved (manually or automatically) in the direction indicated by arrow Y in FIG. 4a. Alternatively, in some embodiments, the tape applicator can be moved, e.g., by a robotic arm. With the addition of this relative motion, liner rewind 125 is able to begin pulling liner. The clutch may be set below some maximum value above which the liner rewind would pull liner even if the substrate were not moved. Generally, the clutch may be set to achieve the desired force required to move the substrate and the tape applicator relative to each other and allow the liner rewind to advance liner 16′. Such a drive system may be referred to as a tendency drive. Alternative tendency drives may also be used.

As shown in FIG. 3, second liner surface 18 of liner 16′ contacts second adhesive surface 12 of tape 10 in liner wrap portion 193. Generally, second liner surface 18 of liner 16′ is selected to provide sufficient adhesion to second adhesive surface 12 to minimize or eliminate slip between them. Thus, as liner 16′ is wound by liner rewind 125, tensioning wheel 120 is rotated pulling additional tape 10 from the tape supply. Various known surface treatments may be used to enhance the bond between second liner surface 18 and second adhesive surface 12; however, the bond should be sufficiently low such that liner 16′ can be removed at point 190c without damaging the second adhesive surface.

In some embodiments, it is desirable to select first liner surface 17 and second liner surface 18 such that the force required to separate second liner surface 18 from second adhesive surface 12 is less than the force required to separate first liner surface 17 from first adhesive surface 11. By increasing the difference in these separation forces, the possibility of liner confusion is reduced. Liner confusion occurs when, during the attempted removal of second liner surface 18 from second adhesive surface 12, the removal force is so great such that tape 10 separates from liner 16 at the interface between first liner surface 17 and first adhesive surface 11 instead.

Tensioning wheel 120 has a fixed radius, R; thus, as it rotates at a fixed angular velocity, W, the linear speed of peripheral surface is constant and equal to W times R (W·R). For a combined thickness T of tape 10 and the portion of liner 16 that is attached to first adhesive surface 11, the linear speed of the tape is W·(R+T/2). Finally, for a thickness L of liner 16′ the linear speed of the liner farthest from the peripheral surface of tensioning wheel (i.e., the portion of liner 16′ in contact with second adhesive surface 12 will be W·(R+T+L/2). Generally, the strain, S, in liner 16′ in liner tensioning portion 192 of liner path 190 is constant and is proportional to the difference in speed between tape 10 and that portion of liner 16′ that is contact with second adhesive surface 12 as tape 10 wraps tensioning wheel 120, divided by the speed of tape 10, i.e.,

$$S ∝ \frac{W \cdot ( R + T + L / 2 ) - W \cdot ( R + T / 2 )}{W \cdot ( R + T / 2 )} ,$$

wherein the symbol ∝ indicates “proportional to.” This can be simplified to

$$S ∝ \frac{( L + T )}{( 2 R + T )} .$$

Thus, regardless of the speed at which the tape is applied, the strain in the liner is constant throughout the application process, and may be set to a desired value for a given tape and liner by selecting the radius of tensioning wheel 120.

As liner 16′ is wound by liner rewind 125, tape 10 is pulled along tape path 180 from the tape supply, around the tensioning roll, and to the applicator roll where it is applied to substrate surface 9. Initially, liner 16 is associated with first adhesive surface 11 and follows tape path 180 with tape 10. Liner 16 is then removed from the tape (at which point it is identified at liner 16′) and continues along liner path 190 where second liner surface 18 contacts second adhesive surface 12, wraps the tensioning wheel, and goes on to be wound at liner rewind 125, as previously described.

Referring to FIG. 4b, when the desired length of tape has been applied to the substrate, idler roll 144 and applicator roll 130 are raised, i.e., moved toward the tensioning wheel. In some embodiments, cutter 160 is positioned between substrate 8 and removed liner 16′. As idler roll 144 and applicator roll 130 are raised, core 14 is brought into contact with cutter 160, severing it. When core 14 is cut, removed liner 16′ is left intact to continue along liner tension portion 192 of liner path 190.

In some embodiments, cutter 160 may be a rotating blade. In some embodiments, lubricant may be intermittently or continuously applied to cutter 160, by e.g., a wick. Generally, the orientation of cutter 160 relative to core 14 may be selected to achieve the desired angle and bevel of cut through the tape. Generally, the position of cutter 160 relative to applicator roll may be selected according to known design considerations. In some embodiments, it may be desirable to position cutter 160 such that core 14 is severed as close as possible to point 190a, i.e., the point where the liner is removed from adhesive surface 11.

In some embodiments, idler roll 144 is coupled to applicator roll 130 so that idler roll 144 is raised simultaneously with and by the same amount as applicator roll 130, i.e., a distance X, relative to their location during tape application as shown in dashed lines by applicator roll 130′ and idler roll 144′. Generally, the remaining elements of linered tape applicator 100 remain fixed relative to the tensioning wheel.

In order to maintain tension in the tape and liner, in some embodiments, raising applicator roll 130 and idler roll 144 toward the tensioning wheel leads to movement of tape 10 (including core 14) and liner 16′. Referring to FIG. 4a, just prior to raising the applicator roll and the idler roll, point 14a indicates the location of core 14 directly below bottom center point of the applicator roll, 130a. Similarly, point 16a indicates the location of liner 16′ directly above top center point of the idler roll 144a.

Referring to FIG. 4b, when the applicator roll and idler roll are raised, tape 10 and liner 16′ shift down web to take up any slack that would form in tape applicator portion 183 of the tape path, and liner tension portions 192 of the liner path. As shown, point 16a shifts as liner 16′ advances clockwise relative to top center point 144a of idler roll 144. Similarly, point 14a shifts as core 14 advances counterclockwise relative to bottom center point 130a of applicator roll 130.

The precise location at which the tape is severed will depend on the position of the cutter relative to the surface of the substrate, the bottom center point of the applicator roll, and the tape. In some embodiments, the movement of the tape relative to the applicator roll as the tape is raised to be cut may be undesirable in some applications. For example, it may be difficult to start applying tape at a precise location on the surface of a substrate.

For example, referring to FIG. 4c, after the tape is cut, a new substrate 8 may be placed below applicator roll 130. Generally, it may be useful to position the substrate such that starting point 9a is under the bottom center point 130a of the applicator roll, where starting point 9a indicates the location on surface 9 where the tape application is intended to begin. However, as shown in FIG. 4c, in some embodiments, when applicator roll 130 and idler roll 144 are lowered, liner 16′ and core 14 shift back upstream.

Specifically, point 16a shifts as liner 16′ retreats counterclockwise relative to top center point 144a of idler roll 144. Similarly, point 14a shifts as core 14 retreats clockwise relative to bottom center point 130a of applicator roll 130. In some embodiments, the location of point 14a is not positioned directly under the center point of the applicator roll. Thus, tape is not applied at the desired starting point 9a, but rather only after substrate 8 has been moved a sufficient amount so as to advance core 14 under the applicator roll and into contact with surface 9.

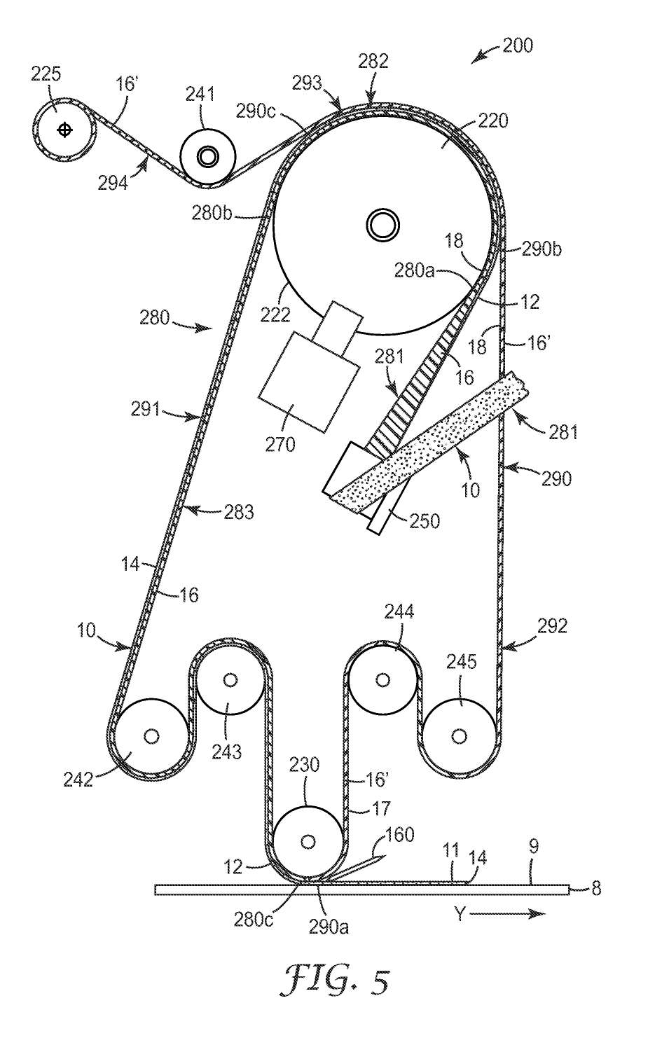

Referring to FIG. 5, exemplary linered tape applicator 200 includes an applicator portion that may reduce or eliminate the movement of the tape relative to the applicator roll if it is a problem in a particular application. Although the applicator portion is described with reference to the exemplary linered tape applicator of FIG. 5, the applicator portions of the present disclosure are not limited to such an applicator.

Referring to FIG. 5, exemplary linered tape applicator 200 may be operated as follows. As shown, idler roll 244 and applicator roll 230 are in their lowered positions relative to tensioning wheel 220 and substrate 8 is positioned below the applicator roll, with tape 10 in contact with substrate surface 9 at the desired pressure. The lowering of the rolls and application of pressure may be achieved using, e.g., pneumatic cylinder or other means known in the art.

Liner rewind 225 is a driven roller operated with a tendency drive, e.g., a clutch drive. The clutch is set such that liner rewind 225 slips when substrate 8 is stationary; thus, no liner is being rewound. Relative motion is then created between the tape applicator and the substrate, e.g., the substrate is moved (manually or automatically) in the direction indicated by arrow Y, causing applicator roll 230 to rotate. With the additional force provided by the motion of the substrate, liner rewind 225 is able to begin pulling liner 16′ as tape is applied to the substrate.

As liner 16′ is wound by liner rewind 225, tensioning wheel 220 is rotated by the liner, pulling additional tape from the tape supply. Because tensioning wheel 220 has a fixed radius, as it rotates at a fixed angular velocity, the linear speed of peripheral surface 222 is constant. Thus, as discussed above, the strain, S, in liner 16′ in liner tensioning portion 292 of liner path 290 is constant and is proportional to the difference in speed between tape 10 and that portion of liner 16′ that is contact with second adhesive surface 12 as tape 10 wraps tensioning wheel 220, divided by the speed of tape 10, which leads to

$$S ∝ \frac{( L + T )}{( 2 R + T )} ;$$

wherein T is the combined thickness of tape 10 and the portion of liner 16 that is attached to first adhesive surface 11, L is the thickness of the portion of liner 16′ in contact with second adhesive surface 12, and R is the radius of tensioning wheel 220. Thus, regardless of the speed at which the tape is applied, the strain in the liner is constant throughout the application process, and may be set to a desired value for a given tape and liner by selecting the radius of tension wheel 220.

As liner 16′ is wound by liner rewind 225, tape 10 is pulled along tape path 280 from the tape supply, around tensioning wheel 220, and to applicator roll 230 where it is applied to substrate surface 9. Tape path 280 includes tape feed portion 281 extending to the peripheral surface 222 of tensioning wheel 220, tape wrap portion 282 forming a first wrap angle relative to the peripheral surface, and tape applying portion 283 extending from the peripheral surface to tape applicator roll 230 where tape 10 is applied to surface 9 of substrate 8. Liner 16 follows liner path 290, which includes linered-tape portion 291 corresponding to the tape path, liner wrap portion 293 forming a second wrap angle relative to the peripheral surface of the tensioning wheel, liner tensioning portion 292 extending from the point where the liner is removed from the first adhesive surface of the tape to the liner wrap portion, and liner rewind portion 294 extending from the liner wrap portion to liner rewind 225.

In some embodiments, when the desired length of tape has been applied to the substrate, brake 270 is used to hold tensioning wheel 220 stationary while the applicator roll is raised and the tape is cut. Generally, the brake may be mechanical (e.g., friction) device that is brought in contact with, e.g., the face or the peripheral edge of the tensioning wheel, preventing the wheel from rotating. Other means of preventing the tensioning wheel may also be used.

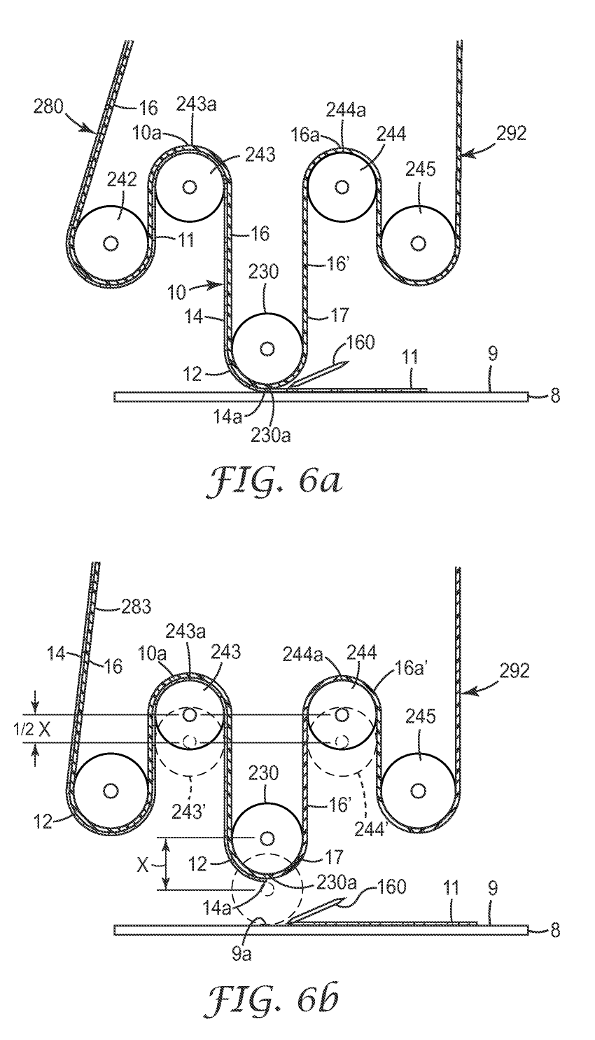

An exemplary applicator portion according to some embodiments of the present disclosure is illustrated in FIGS. 6a and 6b. Referring to FIG. 6a, after the desired length of tape has been applied to a substrate, applicator roll 230 and idler rolls 242 and 243 are initially in their lowered positions. Tape path 280 leads tape 10 from the tensioning wheel (not shown) to idler roll 242, where liner 16 contacts its peripheral surface. First adhesive surface 11 of core 14 then contacts the peripheral surface of idler roll 243. In some embodiments, the peripheral surface of idler roll 243 is treated (e.g., plasma coated) to reduce or eliminate adhesion to first adhesive surface 11. Tape 10 then continues under applicator roll 230 where second adhesive surface 12 bonds core 14 to surface 9 of substrate 8. Liner 16′ is removed from first adhesive surface 11 and continues around idler rolls 244 and 245 before continuing along liner tensioning portion 292 of the liner path to the tensioning wheel (not shown) and the liner rewind (not shown).

When the desired amount of tape is applied to the substrate, motion of the substrate relative to the applicator roll is stopped, and, in some embodiments, a brake is applied to the tensioning wheel. At this point, tape 10 is stationary relative to the tape applicator. The position of the tape, core, and liner relative to various rolls is shown in FIG. 6a. First, reference point 10a indicates the location of tape 10, including liner 16, which is at top center point 243a of idler roll 243. Similarly, reference point 16a indicates the location of liner 16′ that is at top center point 244a of idler roll 244. Finally, reference point 14a indicates the location of core 14 that is at bottom center point 230a of applicator roll 230.

Generally, applicator roll 230 and idler rolls 243 and 244 are coupled to one or more raising mechanisms. Referring to FIG. 6b, when applicator roll 230 is raised by an amount X, idler rolls 243 and 244 are also raised. However, unlike the applicator portion illustrated in FIGS. 4a, 4b, and 4c where the applicator roll and the idler roll were each raised by the same amount, idler rolls 243 and 244 are each only raised by only one-half X when applicator roll 230 is raised by a distance, X.

A variety of raising mechanisms are available to raise the applicator roll by a distance X, and the idler rolls by a distance of one-half X. For example, in some embodiments, separate air pistons may be used, with one piston controlling the motion of the applicator roll, and at least one additional piston controlling the motion of the idler rolls.

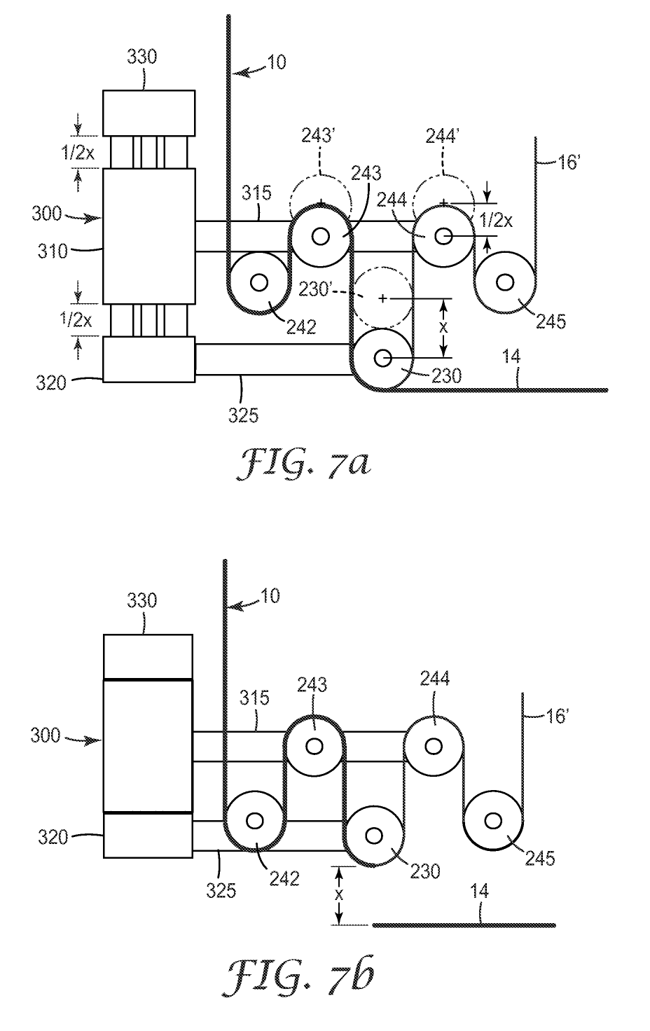

In some embodiments, a single device may be used to raise all three rollers. Referring to FIGS. 7a and 7b, a schematic of gripper cylinder 300 connected to parts of the applicator portion of a tape applicator is shown. Gripper cylinder 300 includes body 310 located between and coupled to top segment 330 and bottom segment 320. The top segment and the bottom segment are movably coupled to the body, i.e., each segment is connected to the body, but is free to move toward and away from the body. In some embodiments, the top segment and body segment are movably coupled to the body such that their relative motion is linked, i.e., when one segment is moved toward or away from the body, the other segment will move simultaneously and by the same amount toward or away from the body. For example, if the top segment is moved toward the body by some distance, the bottom segment will also move toward the body by that same distance.

In typical use, the body of a gripper cylinder is fixed, and the top and bottom segment are simultaneously moved equal distances toward or away from the body. However, in the system shown schematically in FIGS. 7a and 7b, the position of top segment 330 is fixed, e.g., by rigidly affixing the top segment to the frame of the applicator. Body 310 and lower segment 320 are then free to move relative to the fixed top segment. Applicator roll 230 is coupled to lower segment 330 by slide arm 325, allowing the distance between the applicator roll and gripper cylinder to be adjusted to achieve a desired tape and liner path. Because it is coupled to lower segment 330, the motion applicator roll 230 will correspond to the motion of the lower segment.

Similarly, idler rolls 243 and 244 are coupled to body 310 via slide arm 315, again allowing the positions of these rolls to be adjusted to alter the tape and liner paths. The motion of idler rolls 243 and 244 will correspond to the motion of the body. The positions of idler rolls 242 and 245 are fixed, completing the path for tape 10 and liner 16′ after it is removed from core 14.

When the desired length of core 14 has been applied, gripper cylinder 300 is operated simultaneously raising lower segment 320 by a distance of one-half X toward body 310, and raising body 310 by a distance of one-half X toward fixed top segment 330. As a result, relative to its applying position, applicator roll 230 is raised by a total distance of X to its raised position indicated in FIG. 7a by dashed circle 230′, while idler rolls 243 and 244 are only raised by a distance of one-half X to their raised positions indicated in FIG. 7a by dashed circles 243′ and 244′, respectively. The relative positions of the various rolls in their raised positions are also shown in FIG. 7b.

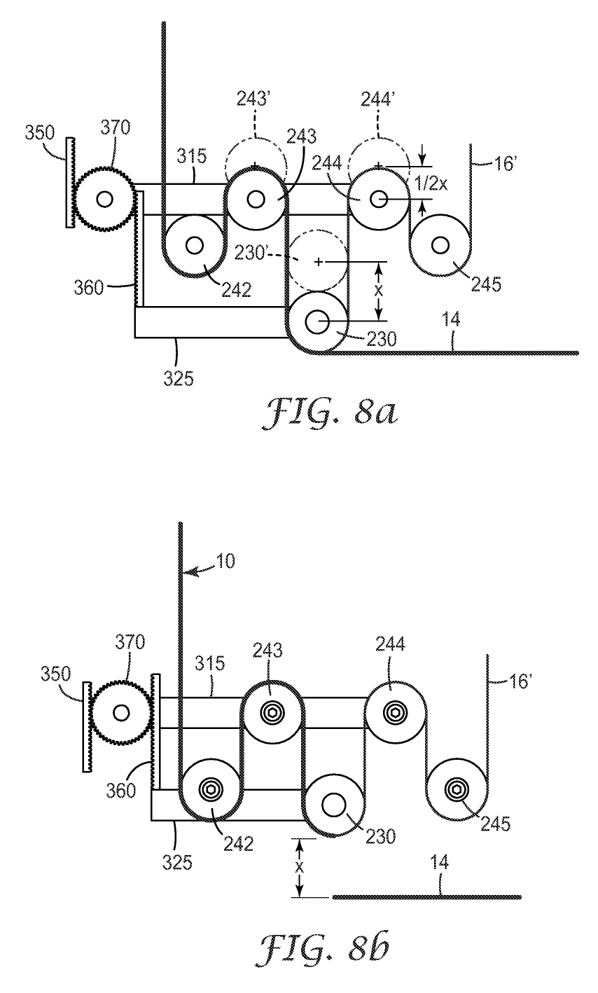

Another raising mechanism for moving the various rollers is shown schematically in FIGS. 8a and 8b. Referring to FIG. 8a, the applicator section of a tape applicator is shown with the applicator and idler rolls in their applying positions. Applicator roll 230 is coupled to movable gear rack 360 via slide arm 325, while idler rolls 243 and 244 are coupled to spur gear 370 via slide arm 315. Spur gear 370 is positioned between and engages both movable gear rack 360 and fixed gear rack 350, which may be rigidly affixed to, e.g., the frame of the tape applicator. Idler rolls 242 and 245 are fixed completing the paths for tape 10 and liner 16′ after it is removed from core 14.

When activated by, e.g., an air piston, applicator roll 230 may be raised by a distance X to its raised position, indicated by dashed circle 230′ in FIG. 8a. As the applicator roll is raised, movable gear rack 360 is raised, rotating spur gear 370. As a result of the motion of movable gear rack 360 relative to spur gear 370 and the rotation of spur gear 370, the spur gear will move by a distance of one-half X relative to fixed gear rack 350. As idler rolls 243 and 244 are coupled to spur gear 370, these rolls will move by a distance of one-half X as applicator roll is moved by a distance X, as desired. The raised positions of idler rolls 243 and 244 are shown in FIG. 8a by dashed circles 243′ and 244′, respectively. The relative positions of the rolls in their raised positions are also shown in FIG. 8b.

Referring again to FIGS. 6a and 6b, in some embodiments, by moving the idler rolls one-half the distance that the applicator roll is moved, the location of core 14 relative to bottom center point 230a of applicator roll 230 is not affected by the motion of the applicator roll or the idler rolls. Specifically, reference point 10a has shifted as tape 10 moves counterclockwise relative to top center point 243a of idler roll 243. Similarly, reference point 16a has shifted as liner 16′ has shifted clockwise relative to top center point 244a of idler roll 244. Thus, by taking up substantially equal amounts of slack both upstream and downstream of the applicator roll, reference point 14a remains stationary at bottom center point 230a of applicator roll 230.

With this arrangement, when a new substrate is placed below the applicator roll, the leading edge of core 14 is positioned to contact surface 9 at desired starting point 9a, located directly below center point 230a of applicator roll 230. Thus, tape can be applied to the appropriate location reliably and reproducibly.

Various modifications and alterations of this invention will become apparent to those skilled in the art without departing from the scope and spirit of this invention.

What is claimed is:

1. An applicator portion of a linered tape applicator comprising an applicator roll, a first idler roll positioned in a tape path prior to the applicator roll and a second idler roll positioned in a liner path subsequent to the applicator roll, wherein the applicator roll, the first idler roll, and the second idler roll are coupled to a raising mechanism, and wherein the raising mechanism is selected such that when the applicator roll is raised by a distance X, the first idler roll and the second idler roll are raised by one-half X.

2. The applicator portion of claim 1, wherein the raising mechanism comprises a gripper cylinder comprising a first segment and a second segment movably coupled to a body positioned there between, wherein the first idler roll and the second idler roll are coupled to the body, and the applicator roll is coupled to the second segment.

3. The applicator portion of claim 2, further comprising a frame, wherein the first segment of the gripper cylinder is affixed to the frame.

4. The applicator portion of claim 2, wherein a first slider arm couples the applicator roll to the second segment of the gripper cylinder.

5. The applicator portion of claim 4, wherein a second slider arm couples the first idler roll and the second idler roll to the body of the gripper cylinder.

6. The applicator portion of claim 1, wherein the raising mechanism comprises a fixed gear rack, a movable gear rack, and a spur gear positioned there between, wherein the first idler roll and the second idler roll are coupled to the spur gear and the applicator roll is coupled to the movable gear rack.

7. The applicator portion of claim 6, further comprising a frame, wherein the fixed gear rack is affixed to the frame.

8. The applicator portion of claim 6, wherein a first slider arm couples the applicator roll to the movable gear rack.

9. The applicator portion of claim 8, wherein a second slider arm couples the first idler roll and the second idler roll to the spur gear.

10. The applicator portion of claim 1, further comprising a third idler roll positioned in the tape path prior to the first idler roll and a fourth idler roll positioned in the liner path subsequent to the second applicator roll.

11. The applicator portion of claim 10, further comprising a frame wherein the third idler roll and the fourth idler are affixed to the frame.

12. A linered tape applicator comprising an applicator portion, wherein the applicator portion comprises an applicator roll, a first idler roll positioned in a tape path prior to the applicator roll and a second idler roll positioned in a liner path subsequent to the applicator roll, wherein the applicator roll, the first idler roll, and the second idler roll are coupled to a raising mechanism, and wherein the raising mechanism is selected such that when the applicator roll is raised by a distance X, the first idler roll and the second idler roll are raised by one-half X.
